(19) United States
(12) Patent Application Publication
(10) Pub. No.: US 2026/0038106 A1
(43) Pub. Date: Feb. 5, 2026

(54) TAB MISALIGNMENT DETECTION METHOD AND APPARATUS, COMPUTER DEVICE, AND STORAGE MEDIUM

(71) Applicant: Tencent Technology (Shenzhen) Company Limited, Shenzhen (CN)

(72) Inventors: Congchong NIE, Shenzhen (CN); Jun LIU, Shenzhen (CN); Chengjie WANG, Shenzhen (CN)

(21) Appl. No.: 19/353,433

(22) Filed: Oct. 8, 2025

Related U.S. Application Data
(63) Continuation of application No. PCT/CN2024/117317, filed on Sep. 6, 2024.

(30) Foreign Application Priority Data
Oct. 17, 2023 (CN) 202311345364.9

(51) Int. Cl. G06T 7/00; G06T 7/60; G06T 7/73

(52) U.S. Cl. CPC G06T 7/0004; G06T 7/60; G06T 7/73; G06T 2207/20081; G06T 2207/30164

(57) ABSTRACT

This application provides a tab misalignment detection method performed by a computer device, The method comprises: performing key point detection on a tab image of a current tab of a lithium-ion battery cell to obtain multiple key point position maps indicating multiple corner points of the current tab respectively; determining, based on the multiple key point position maps, position information of the current tab, the position information indicating positions of the multiple corner points of the current tab in the tab image; determining, based on the position information, an actual width of the current tab; and determining that the current tab is misaligned when a difference between the actual width and a preset width that is greater than a difference threshold.

### CROSS-REFERENCE TO RELATED APPLICATIONS

This application is a continuation application of PCT Patent Application No. PCT/CN2024/117317, entitled “TAB MISALIGNMENT DETECTION METHOD AND APPARATUS, COMPUTER DEVICE, AND STORAGE MEDIUM” filed on Sep. 6, 2024, which claims priority to Chinese Patent Application No. 202311345364.9 entitled “Tab misalignment detection method and apparatus, computer device, and storage medium” filed on Oct. 17, 2023, both of which are incorporated herein by reference in their entirety.

### FIELD OF THE TECHNOLOGY

This application relates to the technical field of batteries, and particularly to a tab misalignment detection technology.

### BACKGROUND OF THE DISCLOSURE

A tab is a metal conductor that leads a positive and a negative electrode out of a battery core, that is, a point of contact with the positive and the negative electrode of a battery during charging and discharging. It is an important component in a lithium-ion polymer battery. In an industrial manufacturing process, due to the influence from the material quality, the separator thickness, the cutting process, and other factors, the tab may be misaligned, which greatly affects the battery performance, and even leads to unacceptable battery quality. Therefore, how to detect whether the tab is misaligned is a problem to be solved.

Currently, the template matching algorithm is usually used for tab misalignment detection. This method is based on the template matching algorithm, in which a tab image taken under back irradiation is processed, and a corner point position of the tab is determined, to determine an offset between an actual width of the tab and a preset width. If the offset is greater than a threshold, the tab is determined to be misaligned, and needs to be adjusted or discarded as useless. If the offset is less than the threshold, the tab is determined to be qualified. However, this method has poor accuracy and robustness, and is susceptible to environmental factors such as irradiation, noise and image quality, causing errors to the detection results.

### SUMMARY

Embodiments of this application provide a tab misalignment detection method and apparatus, a computer device, and a storage medium. The present method is not only applicable to multiple extreme tab conditions, but also suitable for use in a complex irradiation environment, and has higher accuracy and robustness. The technical solution is as follows.

In one aspect, a tab misalignment detection method is provided, which is implemented by a computer device. The method includes:
performing key point detection on a tab image of a current tab of a lithium-ion battery cell to obtain multiple key point position maps indicating multiple corner points of the current tab respectively;
determining, based on the multiple key point position maps, position information of the current tab, the position information being used for indicating positions of the multiple corner points of the current tab in the tab image;
determining, based on the position information, an actual width of the current tab; and
determining that the current tab is misaligned when a difference between the actual width and a preset width that is greater than a difference threshold.

In another aspect, a computer device is provided, the computer device including a processor and a memory, the memory being configured to store at least one computer program, the at least one computer program being loaded and executed by the processor and causing the computer device to implement the tab misalignment detection method in the embodiment of this application.

In another aspect, a non-transitory computer-readable storage medium is provided, the computer-readable storage medium storing at least one computer program, the at least one computer program being loaded and executed by a processor of a compute device and causing the computer device to implement the tab misalignment detection method in the embodiment of this application.

In the tab misalignment detection method provided in this application, key point detection is carried out on the tab image taken under front irradiation. The tab image used in this application is taken under front irradiation. Compared with a tab image taken under back irradiation, the tab and separator can be easily distinguished through colors in the tab image taken under front irradiation. This facilitates the identification of the corner point of the tab. Therefore, in this application, the key point position maps can be more accurately detected based on the tab image taken under front irradiation, then the positions of the corner points of the tab in the tab image are determined based on the key point position maps, and the difference between the actual width of the tab and the preset width is determined, whereby whether the tab is qualified is determined. Compared with a method for processing a tab image taken under back irradiation by using a template matching algorithm, the present method facilitates the identification of the corner point of the tab, and is not only applicable to multiple extreme tab conditions, but also suitable for use in a complex irradiation environment, and has higher accuracy and robustness.

### BRIEF DESCRIPTION OF THE DRAWINGS

To describe the technical solutions of the embodiments of this application more clearly, the drawings needed to be used in the description of the embodiments will be described briefly below. Apparently, the drawings in the following description only show some embodiments of this application. Other drawings can be obtained by a person of ordinary skill in the art from these accompanying drawings without creative efforts.

FIG. 1 schematically shows an application environment of a tab misalignment detection method provided in an embodiment of this application.

FIG. 2 shows a flowchart of a tab misalignment detection method provided in an embodiment of this application.

FIG. 3 shows a flowchart of another tab misalignment detection method provided in an embodiment of this application.

FIG. 4 schematically shows a tab corner point provided in an embodiment of this application.

FIG. 5 schematically shows an extreme tab corner point provided in an embodiment of this application.

FIG. 6 shows a block diagram of a tab misalignment detection apparatus provided in an embodiment of this application.

FIG. 7 is a schematic structural diagram of a terminal provided in an embodiment of this application.

FIG. 8 is a schematic structural diagram of a server provided in an embodiment of this application.

### DESCRIPTION OF EMBODIMENTS

To make the objects, technical solutions and advantages of the embodiments of this application clearer, the implementations of this application will be described in further detail with reference to the accompanying drawings.

In this application, the terms “first”, “second”, and the like are used to distinguish the same or similar items with basically the same effect and function. The words “first”, “second”, and “nth” have no logical or chronological dependency therebetween, have no restriction on the number and execution order.

In this application, the term “at least one” refers to one or more, and “multiple” refers to two or more.

The information (including, but not limited to, the user equipment information, and the user personal information, etc.), the data (including, but not limited to, data for analysis, stored data, and presented data, etc.) and signals involved in this application are all authorized by the users or fully authorized by all parties. The collection, use and processing of relevant data need to comply with relevant laws, regulations and standards of relevant countries and regions. For example, the tab image, backlit image, and others involved in this application are all obtained under full authorization.

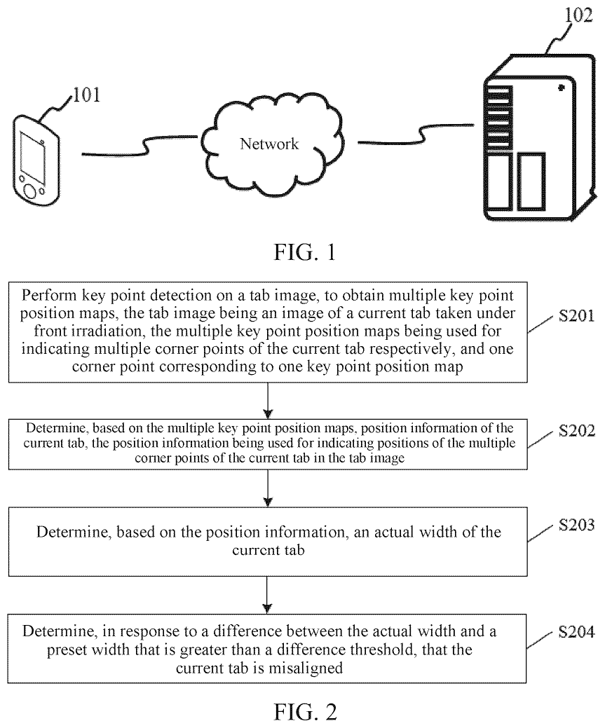

FIG. 1 schematically shows an implementation environment of a tab misalignment detection method provided in an embodiment of this application. As shown in FIG. 1, the implementation environment includes a terminal 101 and a server 102. The terminal 101 and the server 102 can be connected directly or indirectly through wired or wireless communication, which is not limited in this application.

In some embodiments, the terminal 101 includes, but is not limited to, a cell phone, a computer, an intelligent voice interaction device, a smart appliance, a vehicle terminal, an aircraft, and the like. An application program can be installed and run on the terminal 101, and the application program can perform key point detection on a tab image taken under front irradiation, to determine whether the tab is qualified. A user can log in to the application program to view the detection results of tab misalignment detection. The application program correlates with the server 102, and the server 102 provides back-end services to the terminal 101.

In some embodiments, the server 102 can be an independent physical server, a server cluster or a distributed system including multiple physical servers, or a cloud server providing basic cloud computing services such as cloud services, cloud databases, cloud computing, cloud functions, cloud storage, network services, cloud communication, middleware services, domain name services, security services, content delivery network (CDN), big data and artificial intelligence platforms.

In some embodiments, the server 102 undertakes the major computing work, and the terminal 101 undertakes the minor computing work; or the server 102 undertakes the minor computing work, and the terminal 101 undertakes the major computing work; or the server 102 and the terminal 101 have a distributed computing architecture therebetween for collaborative computing.

FIG. 2 shows a flowchart of a tab misalignment detection method provided in an embodiment of this application. The method is executed by a computer device. As shown in FIG. 2, the method includes the following operations:

201: Perform key point detection on a tab image, to obtain multiple key point position maps, the tab image being an image of a current tab taken under front irradiation, the multiple key point position maps being used for indicating multiple corner points of the current tab respectively, and one corner point corresponding to one key point position map.

In the embodiment of this application, a terminal performs key point detection on a tab image, to obtain multiple key point position maps. The tab image is an image of a current tab taken under front irradiation, and the current tab is a tab that needs tab misalignment detection currently. In this way, whether the tab is misaligned is detected. Compared with an image of the current tab taken under back irradiation, positions of corner points in the image of the current tab taken under front irradiation are much clearer. The key point detection is used for automatically detecting and identifying key points of a particular object in a given image, and the key point detection involves a key point regression method and a key point classification method. In the embodiment of this application, the key point detection on the tab image is to process the tab image based on the key point regression method. The key point may be a corner point, an edge point, a bright point in a dark region or a dark point in a bright region. In the embodiment of this application, the key point may be a corner point of the current tab, that is, an edge point of the current tab in contact with a battery core body. The size of the key point position map is the same as the tab image, each key point position map indicates one corner point of the current tab, and different key point position maps indicate different corner points of the current tab. The current tab may be a tab that needs tab misalignment detection, and the number may be one or more, which is not limited in the embodiment of this application.

202: Determine, based on the multiple key point position maps, position information of the current tab, the position information being used for indicating positions of the multiple corner points of the current tab in the tab image.

In the embodiment of this application, the terminal determines, based on each key point position map, a position of one corner point of the current tab in the tab image. Correspondingly, based on the multiple key point position maps, the position of each corner point of the current tab in the tab image can be determined, to determine the position of the current tab in the tab image, that is, the position information of the current tab.

203: Determine, based on the position information, an actual width of the current tab.

In the embodiment of this application, the current tab may be a single tab on the battery core, or two tabs on the battery core. In the embodiment of this application, the current tab includes a positive electrode tab and a negative electrode tab, which is not limited in the embodiment of this application. For any tab, the actual width of the tab can be determined based on the positions of two corner points of the tab.

204: Determine, in response to a difference between the actual width and a preset width that is greater than a difference threshold, that the current tab is misaligned.

In the embodiment of this application, when the difference between the actual width of the current tab and the preset width is greater than the difference threshold, the terminal determines that the current tab is misaligned, and needs to be adjusted or discarded as useless. The preset width is a standard width of the current tab, and the preset width depends on the capacity of a battery having the current tab. For example, for a battery having a capacity of less than 2000 mAh (milliampere-hour), the preset width of the tab may be 4 mm (millimeter); for a battery having a capacity of 2000 mAh to 3000 mAh, the preset width of the tab may be 5 mm; and for a battery having a capacity of over 3000 mAh, the preset width of the tab may be 6 mm. The battery core having the current tab is prepared by stacking or winding. In both a stacked and a wound battery core, the current tab may be misaligned, that is, an upper structure and a lower structure are not completely overlapped.

The embodiment of this application provide a tab misalignment detection method, in which key point detection is carried out on the tab image taken under front irradiation. The tab image used in this application is taken under front irradiation. Compared with a tab image taken under back irradiation, the tab and separator can be easily distinguished through colors in the tab image taken under front irradiation. This facilitates the identification of the corner point of the tab. Therefore, in this application, the key point position maps can be more accurately detected based on the tab image taken under front irradiation, then the positions of the corner points of the tab in the tab image are determined based on the key point position maps, and the difference between the actual width of the tab and the preset width is determined, whereby whether the tab is qualified is determined. Compared with a method for processing a tab image taken under back irradiation by using a template matching algorithm, the present method facilitates the identification of the corner point of the tab, and is not only applicable to multiple extreme tab conditions, but also suitable for use in a complex irradiation environment, and has higher accuracy and robustness.

In the embodiment of this application, multiple methods of performing key point detection on the tab image to obtain multiple key point position maps are provided. In a possible implementation, the multiple key point position maps are multiple key point heat maps, and the method of performing key point detection on the tab image to obtain multiple key point position maps may be processing the tab image by using a key point detection model, to obtain multiple key point heat maps. The key point detection model is used for performing key point detection on an inputted image. The key point detection model may be pre-trained.

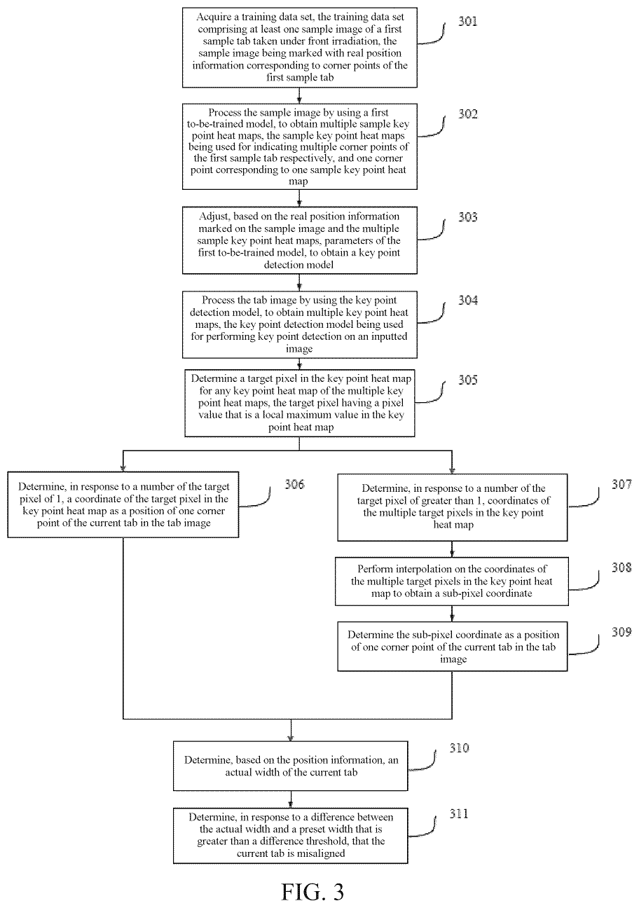

FIG. 3 shows a flowchart of another tab misalignment detection method provided in an embodiment of this application. The method is executed by a computer device. As shown in FIG. 3, the method includes the following operations:

301: Acquire a training data set, the training data set comprising at least one sample image of a first sample tab taken under front irradiation, the sample image being marked with real position information corresponding to corner points of the first sample tab.

In the embodiment of this application, the sample image can be obtained by shooting the first sample tab by a high-resolution camera installed on a production line. The corner point of the first sample tab is an edge point of the first sample tab in contact with the battery core body. For example, the first sample tab has two tabs. Generally, the sample image includes a positive electrode tab and a negative electrode tab. Correspondingly, the first sample tab has four corner points in total, where the positive electrode tab has two corner points, and the negative electrode tab has two corner points. The number and position of the corner points of the first sample tab are not limited in the embodiment of this application.

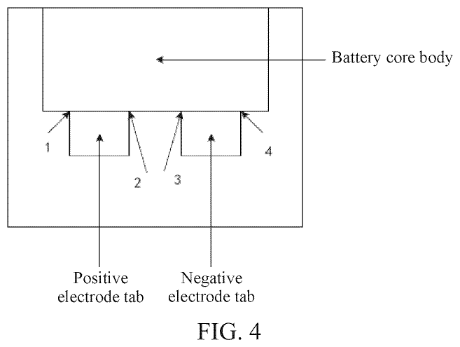

The sample image in the training data set is an image of the first sample tab taken under front irradiation. The front irradiation means that a direction of irradiation of the light source is the same as a shooting direction of the camera. On the contrary, the back irradiation means that the direction of irradiation of the light source is opposite to the shooting direction of the camera. Each sample image is marked with the real position information of the corner point of the first sample tab. Referring to FIG. 4, FIG. 4 schematically shows a tab corner point provided in an embodiment of this application. As shown in FIG. 4, the first sample tab includes a positive electrode tab and a negative electrode tab, and the corner points of the first sample tab are respectively marked as 1, 2, 3, and 4.

In some embodiments, the real position information of the corner points of the first sample tab in the sample image may be marked by manual marking, automatic marking, or automatic marking and manual marking in combination. Usually, the real position information of the corner points of the first sample tab in the sample image is marked by manual marking, to ensure the accuracy of the real position information of the corner points of the first sample tab. However, when the number of the sample images is too large, to avoid the high cost, the real position information of the corner points of the first sample tab in the sample image is marked firstly by automatic marking, and then the incorrectly marked real position information is corrected by manual marking, to ensure the accuracy of the real position information of the corner points of the first sample tab in the sample image.

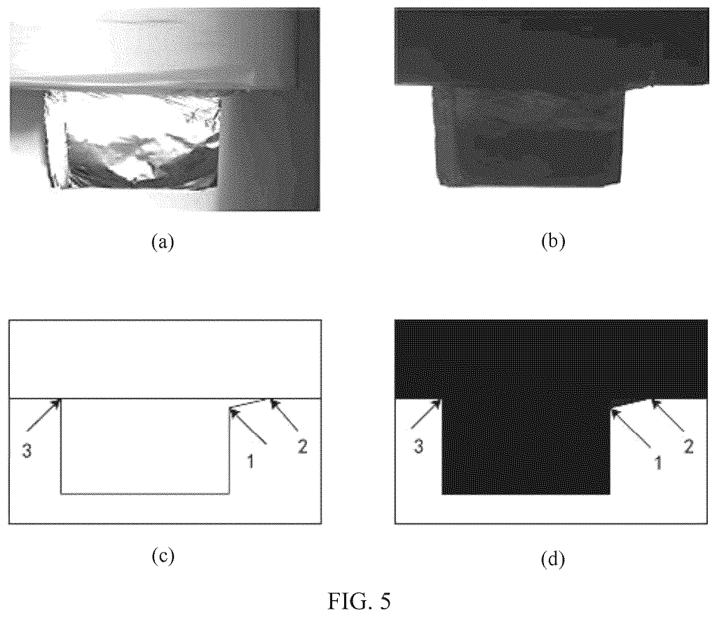

In some embodiments, the training data set can include a sample image indicating extreme tab corner point conditions, including tab misalignment, tab curling, and tab turn-over. Referring to FIG. 5, FIG. 5 schematically shows an extreme tab corner point provided in an embodiment of this application. For example, the first sample tab is a single tab. In FIG. 5, image (a) is an image of the tab taken under front irradiation, image (b) is an image of the tab taken under back irradiation, image (c) is a simplified view of an image of the tab taken under front irradiation, and image (a) is a simplified view of an image of the tab taken under back irradiation. In a wound battery core, when the winding needle is pulled out, a problem may occur that the separator is pulled out, that is, the separator close to the winding needle is partially pulled out with the winding needle. As shown in image (a) in FIG. 5, in the image obtained by shooting the tab under front irradiation, the whole battery core presents various gray values on the image. Because the separator is translucent, the tab and the separator can be distinguished by color, whereby the real position information of the tab corner point can be determined. As shown in image (c) in FIG. 5, the left tab corner point is 3, and the right tab corner point is 1. As shown in image (b) in FIG. 5, in the image obtained by shooting the tab under back irradiation, the whole battery core appears black on the image, and the background is white. Because the translucent state of the separator is not significant, the tab is difficult to be distinguished from the separator by color, whereby it is difficult to determine the real position information of the tab corner point. As shown in image (d) in FIG. 5, the left tab corner point is 3, and the right tab corner points different to be determined are 1 or 2. That is, in the case of some extreme tab corner points, the image obtained by shooting the tab under back irradiation has defects, which may lead to the failure to determine the real position information of the tab corner points. Therefore, the sample image in the training data set is an image obtained by shooting the tab under front irradiation.

As the number of the sample image included in the training data set increases, the detection performance of the key point detection model obtained with the training data set becomes better. As the types of sample images indicating extreme tab corner point conditions included in the training data set become more abundant, the detection performance of the key point detection model obtained with the training data set becomes better.

In some embodiments, the sample image in the training data set is obtained by performing data pre-processing on the original image taken. The data pre-processing includes translation, small-angle rotation and normalization of the image. Through data pre-processing, the position deviation of a mechanical arm on a practical production line can be simulated, to improve the generalization ability of the key point detection model obtained by using the training data set.

302: Process the sample image by using a first to-be-trained model, to obtain multiple sample key point heat maps, the sample key point heat maps being used for indicating multiple corner points of the first sample tab respectively, and one corner point corresponding to one sample key point heat map.

During a training process, the terminal processes the sample image by using a first to-be-trained model, to obtain a sample key point heat map corresponding to each corner point.

The model structure of the first to-be-trained model is not limited in the embodiment of this application. In a possible implementation, the first to-be-trained model may be a high-resolution network (HRnet) model. HRnet mainly includes a high-resolution subnetwork and a multi-scale fusion module. The first to-be-trained model may be other models using a key point detection algorithm, which is not limited in the embodiment of this application.

The high-resolution subnetwork is configured to enable a feature map to persistently retain a high resolution during the whole processing process by the model, to avoid the problems of information loss and information ambiguity caused by the reduction in resolution of the feature map. The high-resolution subnetwork includes multiple residual modules, and each residual module includes two convolutional layers and one skip connection. The convolutional layer is configured to perform feature extraction and feature mapping on inputted data by an operation of convolution, so as to output a corresponding feature map. The skip connection is to add an input directly to an output, so that information can be passed directly from the input to the output. The skip connection serves to avoid the problems such as vanishing gradient and exploding gradient. The input of the high-resolution subnetwork is the sample image (H×W×3), and the output is a high-resolution feature map. The size of the sample image is H×W, that is, the height is H, and the width is w; and the number of channels is 3.

The multi-scale fusion module is configured to fuse context information of various scales, that is, feature map information of multiple resolutions. The multi-scale fusion module includes sub-networks of multiple resolutions, and the sub-network of each resolution corresponds to one residual module. The sub-networks exchange information through up-sampling and down-sampling operations. An output of the multi-scale fusion module is a high-resolution feature map with fused multi-scale information.

That is, the HRnet includes multiple scale branches, and an output of each scale branch is a feature map with fused multi-scale information. However, the last output layer of HRnet only outputs the highest-resolution feature map with fused multi-scale information, that is, the sample key point heat map.

For example, the input of HRnet is the sample image (64×64×3), that is, the input image is a 3-channel sample image having a height of 64 pixels and a width of 64 pixels. At this time, after passing through a convolutional layer, a 4× downsampled scale branch is obtained, that is, a feature map having a height of 32 pixels and a width of 32 pixels is obtained. Then, after passing through another convolutional layer, a 8× downsampled scale branch is obtained, that is, a feature map having a height of 16 pixels and a width of 16 pixels is obtained. Similarly, a 16× downsampled scale branch and a 32× downsampled scale branch can be obtained. During this process, the output on each scale branch is obtained by fusing the outputs on all the scale branches. That is, the scale branches are fused in the form of full connection. At the final output, the outputs of the downsampled scale branches obtained are respectively upsampled by corresponding multiples, and all the corresponding outputs are added and then processed. After that, the highest-resolution feature map with fused multi-scale information is obtained. Namely, the output of HRnet is a feature map having a height of 64 pixels and a width of 64 pixels, that is, the sample key point heat map.

In a conventional tab misalignment detection method, the model matching algorithm is used for the detection on the image of the tab taken under back irradiation. In the case of some extreme tab corner points, the image obtained by shooting the tab under back irradiation has defects, which may lead to the failure to determine the real position information of the tab corner points. Therefore, the sample image in the training data set is an image obtained by shooting the tab under front irradiation. The template matching algorithm is used for tab misalignment detection, which needs to slide a standard tab template in the sample image and calculate the matching degree, to find the most matching position with the standard tab template, and then determine the position information of the tab corner point. However, in the image of the tab taken under front irradiation, the wrinkles on a surface of a copper tab and an aluminum tab lead to uneven image brightness, That is, the whole battery core presents various gray values on the image, which will interfere with the matching process. Therefore, the key point detection algorithm is used to replace the template matching algorithm.

303: Adjust, based on the real position information marked on the sample image and the multiple sample key point heat maps, parameters of the first to-be-trained model, to obtain a key point detection model.

In the embodiment of this application, based on the marks on the sample image, the real position information of the tab corner points can be determined; and based on the sample key point heat maps, predicted position information of the tab corner points can be determined. The real position information of the tab corner point is compared with the predicted position information of the tab corner point, and the parameters of the first to-be-trained model are adjusted, to complete the training. In this way, the key point detection model with better detection performance is obtained. The key point detection model has the same model structure with that of the first to-be-trained model, but the parameters are optimized.

In the process of training the key point detection model, a label heat map is used as a label for training. The label heat map is obtained based on the sample image. A pixel value of a key point in the label heat map is 1, and pixel values of other pixel points decrease according to Gaussian distribution. That is, the pixel value at the key point is the maximum, and the pixel values around the key point decreases radially. When the pixel value of the key point in the label heat map is 1 and the pixel values of the pixel points at other positions are 0, not only the small number of positive samples will increase the training difficulty, but also the training effect of the key point detection model will be affected when the real position information of the marked polar corner points has errors. Therefore, the pixel value of the key point in the label heat map is 1, and the pixel values of the pixel points at other positions decrease according to the Gaussian distribution.

304: Process the tab image by using the key point detection model, to obtain multiple key point heat maps, the key point detection model being used for performing key point detection on an inputted image.

In the embodiment of this application, after the key point detection model is obtained by training, the terminal can process the tab image by the key point detection model, to obtain the key point heat map corresponding to each corner point. The tab image is the image of the current tab taken under front irradiation. The tab image can be obtained by shooting the tab by a high-resolution camera installed on the production line. Compared with an image of the current tab taken under back irradiation, positions of corner points in the image of the current tab taken under front irradiation are much clearer. The key point may be a corner point of the current tab, that is, an edge point of the current tab in contact with the battery core body, which is used for indicating a width range of the current tab. The size of the key point heat map is the same as the tab image, the multiple key point heat maps are used for indicating multiple corner points of the current tab respectively, one corner point corresponds to one key point heat map, and the key point heat maps corresponding to different corner points are different.

In some embodiments, the features in the image of the current tab under front irradiation and the image of the current tab under back irradiation can be combined for key point detection. Correspondingly, feature extraction is performed on the tab image, to obtain a first feature map; feature extraction is performed on a backlit image, to obtain a second feature map, where the backlit image is an image of the current tab taken under back irradiation; the first feature map and the second feature map are fused, to obtain a fused feature map; and key point detection is performed based on the fused feature map, to obtain multiple key point position maps.

The multi-modal fusion of the tab image and the backlit image can provide more information about the current tab. The tab image and the backlit image are inputted into two feature extraction networks with shared weights, for feature extraction and multi-scale fusion. The obtained fused feature map is inputted into the key point detection model, and processed to obtain multiple key point heat maps.

In some embodiments, the tab image and the backlit image can be spliced, and multiple key point position maps are obtained based on the spliced image. For example, the backlit image is a single-channel image, and the tab image is a three-channel image. After the backlit image and the tab image are spliced, a four-channel spliced image is obtained. The spliced image is input into the key point detection model, and processed to obtain multiple key point heat maps.

305: Determine a target pixel in the key point heat map for any key point heat map of the multiple key point heat maps, the target pixel having a pixel value that is a local maximum value in the key point heat map.

In the embodiment of this application, for any key point heat map, the terminal determines a target pixel in the key point heat map.

In the key point heat map corresponding to any corner point, a corresponding pixel value of the corner point is the maximum. Therefore, a local maximum value of all pixel values in the key point heat map is determined, and a target pixel corresponding to the local maximum value is determined. To eliminate the influence of noise points, the local maximum value is used to replace the global maximum value. That is, noises are removed from the key point heat map, and then the local maximum value is determined by using a peak function.

Coordinates of the key points can be obtained by direct prediction, with no need to determine the coordinates of the key points after the key point heat maps are obtained. Accordingly, this method has low computational complexity and requirements for internal memory, which is not limited in the embodiment of this application.

The number of target pixels can be 1, or more than 1. Correspondingly, when the number of the target pixel is 1, operation 306 is performed; and when the number of the target pixel is more than 1, operations 307 to 309 are performed.

306: Determine, in response to a number of the target pixel of 1, a coordinate of the target pixel in the key point heat map as a position of one corner point of the current tab in the tab image.

In the embodiment of this application, when the number of the target pixel is 1, the terminal determines, according to the coordinate of the target pixel in key point heat map, the position of a corresponding corner point of the current tab in the tab image. One target pixel corresponds to one coordinate in the key point heat map. In some embodiments, the origin point of the coordinate axes can be located in the upper left corner of the key point heat map, with the horizontal axis being the X axis and the vertical axis being the Y axis. Because the size of the key point heat map is the same as the tab image, the coordinate of the target pixel in the key point heat map can be used as the coordinate of the corner point corresponding to the key point in the tab image. That is, the position of the corner point corresponding to the key point in the tab image can be determined.

307: Determine, in response to a number of the target pixel of greater than 1, coordinates of the multiple target pixels in the key point heat map.

In the embodiment of this application, when the number of the target pixel is more than 1, the terminal determines the coordinates of all the target pixels in the key point heat map.

308: Perform interpolation on the coordinates of the multiple target pixels in the key point heat map to obtain a sub-pixel coordinate.

In the embodiment of this application, because the number of the target pixel is greater than 1 and the coordinates of the target pixels in the key point heat map are usually integer coordinates, to determine accurate coordinates and improve the prediction accuracy, interpolation is performed on the coordinates of the multiple target pixels in the key point heat map, including bilinear interpolation and cubic spline interpolation. The corresponding sub-pixel coordinates are obtained, and pixel values corresponding to the sub-pixel coordinates are local maximum values.

The specific method of the interpolation operation is not limited in the embodiment of this application. Interpolation means to estimate an approximate value of a function at other points through values of the function at a limited number of points. The bilinear interpolation is an extension of linear interpolation on a two-dimensional Cartesian grid, that is, the linear interpolation is carried out once in the x direction and the y direction respectively. The cubic spline interpolation means to divide an original long sequence into several segments and construct a cubic function for each segment, so that the joints between the segments can be smooth.

309: Determine the sub-pixel coordinate as a position of one corner point of the current tab in the tab image.

In the embodiment of this application, because the size of the key point heat map is the same as the tab image, the sub-pixel coordinate can be used as the coordinate of the corresponding corner point in the tab image. That is, the position of the corner point in the tab image can be determined.

When the key point position maps are used for key point detection, if the number of corner points of which the positions are to be determined in the tab image changes, the key point detection model needs to be trained again. That is, in the case of a different number of the tab corner points, a different key point detection model needs to be used for key point detection. In this case, to avoid re-training, in some embodiments, the positions of the corner points of the current tab in the tab image can be determined based on the key point position maps obtained by target detection. The method using target detection can not only be for tab misalignment detection, but also be combined with other tasks, such as fold detection; and the method using target detection is not limited by the number of the corner point, so it is more versatile.

In some embodiments, the key point position maps can be obtained by a target detection model. Accordingly, target detection is performed on the tab image by using the target detection model, to obtain multiple key point position maps.

In some embodiments, the target detection model is trained firstly. Correspondingly, a sample data set is obtained, the sample data set comprising at least one image of a second sample tab taken under front irradiation, the image in the sample data set being marked with sample marking frames, the sample marking frame being an square area centered on a corresponding corner point of the second sample tab; the image in the sample data set is processed by using a second to-be-trained model, to obtain multiple sample key point position maps, the sample key point position maps being used for indicating multiple corner points of the second sample tab respectively, and one corner point corresponding to one sample key point position map; and based on the sample marking frames on the image in the sample data set and the multiple sample key point position maps, parameters of the second to-be-trained model is adjusted, to obtain the target detection model. For example, after 100 pixels are extended around the corner point, the sample marking frame refers to a square area with a side length of 200 pixels centered on the corner point.

In some embodiments, the positions of the corner points of the current tab in the tab image can be determined based on the marking frames in the key point position maps. Accordingly, the method of determining the position information of the current tab based on the multiple key point position maps can be determining the position of the marking frame in the key point position map for any key point position map of the multiple key point position maps; and determining the position of the marking frame as the position of the corner point in tab image. The position of the center point of the marking frame is determined as the position of the corner point in tab image.

310: Determine, based on the position information, an actual width of the current tab.

In the embodiment of this application, the terminal determines, based on the position information of the current tab, an actual width of the current tab. The current tab may be one tab on the battery core or two tabs on the battery core, which is not limited in the embodiment of this application.

In some embodiments, the current tab includes a positive electrode tab and a negative electrode tab. The terminal determines, based on the position information, two corner points of the positive electrode tab and two corner points of negative electrode tab. The terminal determines an Euclidean distance between the two corner points of the positive electrode tab as the actual width of the positive electrode tab; and the terminal determines an Euclidean distance between the two corner points of the negative electrode tab as the actual width of the negative electrode tab.

311: Determine, in response to a difference between the actual width and a preset width that is greater than a difference threshold, that the current tab is misaligned.

In the embodiment of this application, when the difference between the actual width of the current tab and the preset width is greater than the difference threshold, the terminal determines that the current tab is misaligned, and needs to be adjusted or discarded as useless. The preset width is a standard width of the current tab, and the difference threshold refers to an allowable error value of the tab width. For different models of tabs, the preset widths and the difference thresholds are not exactly the same. For example, tab model A has a preset width of 2 mm and a difference threshold of 0.02 mm; tab model B has a preset width of 3 mm, and a difference threshold of 0.05 mm; tab model C has a preset width of 4 mm and a difference threshold of 0.05 mm.

In some embodiments, the terminal determines, in response to the difference between the actual width and the preset width that is not greater than the difference threshold, that the current tab is qualified. Because errors are inevitable in production activities, there is a difference between the actual width of the current tab and the preset width. When the difference is not greater than the difference threshold, the current tab is determined to be qualified. For example, tab model A has a preset width of 2 mm and the difference threshold is 0.02 mm. After the tab misalignment detection method is applied, the actual width of tab model A is determined to be 2.01 mm. In this case, the difference between the actual width of tab model A and the preset width is 0.01 mm, and the difference is less than the difference threshold, indicating that it is a reasonable error value. Therefore, tab model A is determined to be qualified.

The key point detection model can not only be used to determine the actual width of the tab, but also determine the relative position between the tab and the battery core body. The key point is a corner point of the tab and an edge point of the battery core body. In fact, to expand the embodiment of this application, the key point can be any point at a fixed position in the standard battery core, which is not limited in the embodiment of this application.

In the embodiment shown in FIG. 3, operation 301-operation 303 show the training process of the key point detection model, operation 304 shows a key point detection process using a key point detection model, operation 305-operation 306 show a method of determining the position information of the current tab based on the multiple key point position maps when the multiple key point position maps are multiple key point heat maps, and operation 307-operation 309 show another method of determining the position information of the current tab based on the multiple key point position maps when the multiple key point position maps are multiple key point heat maps. Operation 301-operation 303, operation 304, operation 305-operation 306, and operation 307-operation 309 can be performed separately. For example, when the key point detection is performed by using the key point detection model, the method of training the key point detection model is not limited in the embodiment of this application. In an implementation, the key point detection model can be trained by the operations shown in operation 301-operation 303. Similarly, operation 305-operation 306 or operation 307-operation 309 do not depend on operation 301-operation 304. When the multiple key point position maps are multiple key point heat maps, in an implementation, the position information of the current tab can be determined by operation 305-operation 306 or operation 307-operation 309.

The embodiment of this application provide a tab misalignment detection method, in which key point detection is carried out on the tab image taken under front irradiation. The tab image used in this application is taken under front irradiation. Compared with a tab image taken under back irradiation, the tab and separator can be easily distinguished through colors in the tab image taken under front irradiation. This facilitates the identification of the corner point of the tab. Therefore, in this application, the key point position maps can be more accurately detected based on the tab image taken under front irradiation, then the positions of the corner points of the tab in the tab image are determined based on the key point position maps, and the difference between the actual width of the tab and the preset width is determined, whereby whether the tab is qualified is determined. Compared with a method for processing a tab image taken under back irradiation by using a template matching algorithm, the present method facilitates the identification of the corner point of the tab, and is not only applicable to multiple extreme tab conditions, but also suitable for use in a complex irradiation environment, and has higher accuracy and robustness.

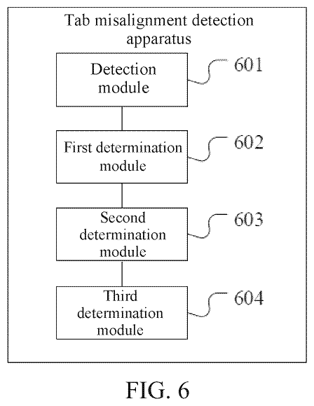

FIG. 6 shows a block diagram of a tab misalignment detection apparatus provided in an embodiment of this application. The apparatus is configured to implement the operations of the tab misalignment detection method when implemented. As shown in FIG. 6, the tab misalignment detection apparatus includes: a detection module 601 a first determination module 602, a second determination module 603, and a third determination module 604.

The detection module 601 is configured to perform key point detection on a tab image, to obtain multiple key point position maps, the tab image being an image of a current tab taken under front irradiation, the multiple key point position maps being used for indicating multiple corner points of the current tab respectively, and one corner point corresponding to one key point position map.

The first determination module 602 is configured to determine, based on the multiple key point position maps, position information of the current tab, the position information being used for indicating positions of the multiple corner points of the current tab in the tab image.

The second determination module 603 is configured to determine, based on the position information, an actual width of the current tab.

The third determination module 604 is configured to determine, in response to a difference between the actual width and a preset width that is greater than a difference threshold, that the current tab is misaligned.

In some embodiments, the multiple key point position maps are multiple key point heat maps, and the detection module 601 is configured to process the tab image by using a key point detection model, to obtain multiple key point heat maps, the key point detection model being used for performing key point detection on an inputted image.

In some embodiments, the detection module 601 is further configured to acquire a training data set, the training data set comprising at least one sample image of a first sample tab taken under front irradiation, the sample image being marked with real position information corresponding to corner points of the first sample tab; process the sample image by using a first to-be-trained model, to obtain multiple sample key point heat maps, the sample key point heat maps being used for indicating multiple corner points of the first sample tab respectively, and one corner point corresponding to one sample key point heat map; and adjust, based on the real position information marked on the sample image and the multiple sample key point heat maps, parameters of the first to-be-trained model, to obtain the key point detection model.

In some embodiments, the detection module 601 is further configured to perform feature extraction on the tab image, to obtain a first feature map; perform feature extraction on a backlit image, to obtain a second feature map, the backlit image being an image of the current tab taken under back irradiation; fuse the first feature map and the second feature map, to obtain a fused feature map; and perform key point detection based on the fused feature map, to obtain multiple key point position maps.

In some embodiments, the detection module 601 is further configured to perform target detection on the tab image by using a target detection model, to obtain multiple key point position maps.

In some embodiments, the detection module 601 is further configured to acquire a sample data set, the sample data set comprising at least one image of a second sample tab taken under front irradiation, the image in the sample data set being marked with sample marking frames, the sample marking frame being an square area centered on a corresponding corner point of the second sample tab; process the image in the sample data set by using a second to-be-trained model, to obtain multiple sample key point position maps, the sample key point position maps being used for indicating multiple corner points of the second sample tab respectively, and one corner point corresponding to one sample key point position map; and adjust, based on the sample marking frames on the image in the sample data set and the multiple sample key point position maps, parameters of the second to-be-trained model, to obtain the target detection model.

In some embodiments, the multiple key point position maps are multiple key point heat maps, and the first determination module 602 is configured to determine a target pixel in the key point heat map for any key point heat map of the multiple key point heat maps, the target pixel having a pixel value that is a local maximum value in the key point heat map; determining, in response to a number of the target pixel of 1, a coordinate of the target pixel in the key point heat map as a position of one corner point of the current tab in the tab image.

In some embodiments, the first determination module 602 is further configured to determine, in response to a number of the target pixel of greater than 1, coordinates of the multiple target pixels in the key point heat map; perform interpolation on the coordinates of the multiple target pixels in the key point heat map to obtain sub-pixel coordinates; and determine the sub-pixel coordinate as a position of one corner point of the current tab in the tab image.

In some embodiments, the first determination module 602 is further configured to determine the position of the marking frame in the key point position map for any key point position map of the multiple key point position maps; and determine the position of the marking frame as the position of the corner point in tab image.

In some embodiments, the current tab includes a positive electrode tab and a negative electrode tab; and

the second determination module 603 is configured to determine, based on the position information, two corner points of the positive electrode tab and two corner points of negative electrode tab; determine an Euclidean distance between the two corner points of the positive electrode tab as the actual width of the positive electrode tab; and determine an Euclidean distance between the two corner points of the negative electrode tab as the actual width of the negative electrode tab.

In some embodiments, the third determination module 604 is configured to determine, in response to a difference between the actual width and a preset width that is not greater than a difference threshold, that the current tab is determined to be qualified.

This application provides a tab misalignment detection apparatus, by which key point detection is carried out on the tab image taken under front irradiation. The tab image used in this application is taken under front irradiation. Compared with a tab image taken under back irradiation, the tab and separator can be easily distinguished through colors in the tab image taken under front irradiation. This facilitates the identification of the corner point of the tab. Therefore, in this application, the key point position maps can be more accurately detected based on the tab image taken under front irradiation, then the positions of the corner points of the tab in the tab image are determined based on the key point position maps, and the difference between the actual width of the tab and the preset width is determined, whereby whether the tab is qualified is determined. Compared with an apparatus for processing a tab image taken under back irradiation by using a template matching algorithm, the present apparatus facilitates the identification of the corner point of the tab, and is not only applicable to multiple extreme tab conditions, but also suitable for use in a complex irradiation environment, and has higher accuracy and robustness.

The tab misalignment detection apparatus provided in the above embodiment is merely described by way of example with reference to the division of functional modules when an application program runs. In practical use, the above functions can be allocated to and implemented by different functional modules. That is, the internal structure in the terminal is divided into different functional modules, so as to implement all or part of the functions described above. In addition, the tab misalignment detection apparatus provided in the above embodiment has the same concept with the embodiment of the tab misalignment detection method, and the specific implementation process is shown in the method embodiment, which will not be described here again.

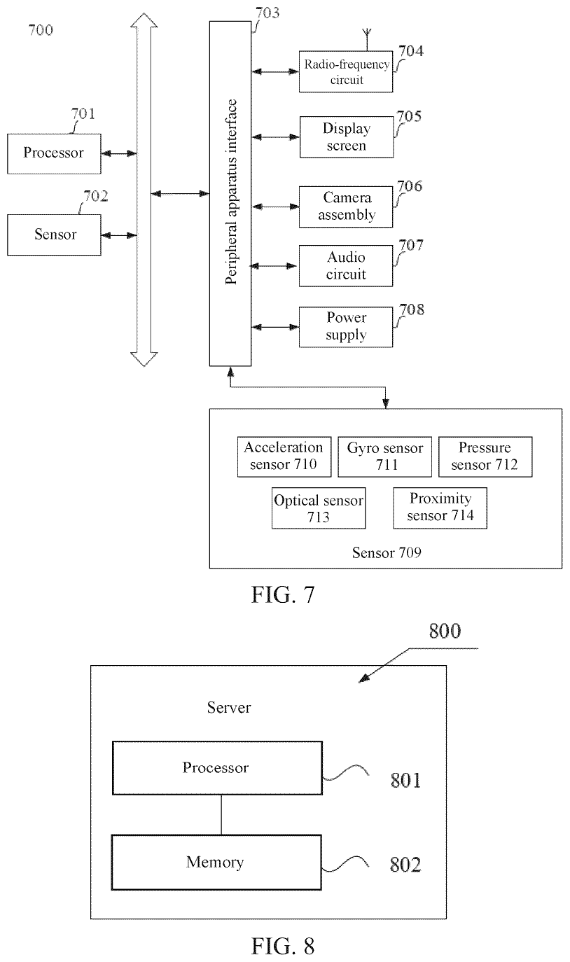

FIG. 7 is a schematic structural diagram of a terminal provided in an embodiment of this application. The terminal 700 may be a portable mobile terminal, for example, a smart phone, a tablet computer, a moving picture experts group audio layer III (MP3) player, a moving picture experts group audio layer IV (MP4) player, a notebook computer or a desktop computer. The terminal 700 may also be called user equipment, portable terminal, laptop terminal, desktop terminal and other names.

Generally, the terminal 700 includes: a processor 701 and a storage 702.

The processor 701 may include one or more processing core, for example, a 4-core processor, and a 8-core processor, etc. The processor 701 can be implemented as at least one hardware form selected from digital signal processing (DSP), field-programmable gate array (FPGA), and programmable logic array (PLA). The processor 701 may also include a master processor and a co-processor, where the master processor is a processor used to process the data in the wake-up state, which also called central processing unit (CPU). The co-processor is a low-power-consumption processor used to process the data in the stand-by state. In some embodiments, the processor 701 may be integrated with a graphics processing unit (GPU), where GPU is used for rendering and drawing the content to be displayed on the screen. In some embodiments, the processor 701 may further include an artificial intelligence (AI) processor, where the AI processor is used for processing computing operations related to machine learning.

The memory 702 may include one or more computer-readable storage media, where the computer-readable storage medium may be non-transitory. The memory 702 may also include a high-speed random access memory and a non-volatile storage medium, such as one or more magnetic disk storage devices and flash memory storage devices. In some embodiments, the non-transitory computer-readable storage medium in the memory 702 is used to store at least one computer program. The at least one computer program is executed by the processor 701 to implement the tab misalignment detection method provided in the method embodiment of this application.

In some embodiments, the terminal 700 further includes: a peripheral apparatus interface 703 and at least one peripheral device. Specifically, the peripheral device includes at least one of: a radio-frequency circuit 704, a display screen 705, a camera assembly 706, an audio circuit 707 and a power supply 708.

In some embodiments, the terminal 700 further includes one or more sensors 709. The one or more sensors 709 include, but are not limited to, an acceleration sensor 710, a gyro sensor 711, a pressure sensor 712, an optical sensor 713, and a proximity sensor 714.

A person skilled in the art can understand that the structure shown in FIG. 7 does not constitute a limitation on the terminal 700, and may include more or less components than shown or have some components combined, or have a different component deployment.

FIG. 8 is a schematic structural diagram of a server provided in an embodiment of this application. The server 800 may be quite different due to different configurations or performances, and may include one or more central processing units (CPUs) 801 and one or more memories 802, where the memory 802 stores at least one computer program. The at least one computer program is loaded and executed by the processor 801 to implement the tab misalignment detection method provided in the various method embodiments. Definitely, the server may also have a wired or wireless network interface, a keyboard, an input and output interface and other components for input and output. The server can also include other components for implement the functions of the apparatus, which will not be described here.

An embodiment of this application further provides a non-transitory computer-readable storage medium. The computer-readable storage medium stores at least one computer program. The at least one computer program is loaded and executed by a processor to implement the tab misalignment detection method in the embodiment. For example, the computer-readable storage medium maybe a read-only memory (ROM), a random access memory (RAM), a compact disc read-only memory (CD-ROM), a magnetic tape, a floppy disk, and an optical data storage device, etc.

An embodiment of this application further provides a computer program product, which includes a computer program. The computer program, when executed by a processor, implements the tab misalignment detection method in the embodiment of this application.

A person of ordinary skill in the art can understand that all or some of the operations in the foregoing embodiments can be implemented through hardware, or may also be implemented by a program instructing related hardware. The program may be stored in a non-transitory computer-readable storage medium. The storage medium mentioned above may be a read-only memory, a magnetic disk, a magnetic disk or an optical disc.

Exemplary embodiments of this application are described above; however, this application is not limited thereto. Any changes, equivalent replacements and improvements made without departing from the spirit and principle of this application are embraced in the scope of protection of this application. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A method for detecting tab misalignment in a lithium-ion battery cell by a computer device, the method comprising:
performing key point detection on a tab image of a current tab of a lithium-ion battery cell to obtain multiple key point position maps indicating multiple corner points of the current tab respectively;
determining, based on the multiple key point position maps, position information of the current tab, the position information indicating positions of the multiple corner points of the current tab in the tab image;
determining, based on the position information, an actual width of the current tab; and
determining that the current tab is misaligned when a difference between the actual width and a preset width that is greater than a difference threshold.

2. The method according to claim 1, wherein the performing key point detection on a tab image to obtain multiple key point position maps comprises:
processing the tab image by using a key point detection model, to obtain multiple key point heat maps.

3. The method according to claim 2, wherein the key point detection model is generated by:
acquiring a training data set, the training data set comprising at least one sample image of a first sample tab taken under front irradiation, the sample image being marked with real position information corresponding to corner points of the first sample tab;
processing the sample image by using a first detection model, to obtain multiple sample key point heat maps, the sample key point heat maps being used for indicating multiple corner points of the first sample tab respectively, and one corner point corresponding to one sample key point heat map; and
adjusting, based on the real position information marked on the sample image and the multiple sample key point heat maps, parameters of the first detection model, to obtain the key point detection model.

4. The method according to claim 1, wherein the performing key point detection on a tab image of a current tab of a lithium-ion battery cell to obtain multiple key point position maps comprises:
performing feature extraction on the tab image, to obtain a first feature map;
performing feature extraction on a backlit image, to obtain a second feature map, the backlit image being an image of the current tab taken under back irradiation;
fusing the first feature map and the second feature map, to obtain a fused feature map; and
performing key point detection based on the fused feature map, to obtain the multiple key point position maps.

5. The method according to claim 1, wherein the performing key point detection on a tab image of a current tab of a lithium-ion battery cell to obtain multiple key point position maps comprises:
performing target detection on the tab image by using a target detection model, to obtain the multiple key point position maps.

6. The method according to claim 5, wherein the target detection model is generated by:
acquiring a sample data set, the sample data set comprising at least one image of a second sample tab taken under front irradiation, the image in the sample data set being marked with sample marking frames, the sample marking frame being an square area centered on a corresponding corner point of the second sample tab;
processing the image in the sample data set by using a second detection model, to obtain multiple sample key point position maps, the sample key point position maps being used for indicating multiple corner points of the second sample tab respectively, and one corner point corresponding to one sample key point position map; and
adjusting, based on the sample marking frames on the image in the sample data set and the multiple sample key point position maps parameters of the second detection model, to obtain the target detection model.

7. The method according to claim 1, wherein the multiple key point position maps are multiple key point heat maps, and the determining, based on the multiple key point position maps, position information of the current tab comprises:
determining a target pixel in the key point heat map for any key point heat map of the multiple key point heat maps, the target pixel having a pixel value that is a local maximum value in the key point heat map;
determining, in response to a total number of the target pixel being 1, a coordinate of the target pixel in the key point heat map as a position of one corner point of the current tab in the tab image;
determining, in response to the total number of the target pixel being greater than 1, coordinates of the multiple target pixels in the key point heat map;
performing interpolation on the coordinates of the multiple target pixels in the key point heat map to obtain a sub-pixel coordinate; and
determining the sub-pixel coordinate as a position of one corner point of the current tab in the tab image.

8. The method according to claim 1, wherein the determining, based on the multiple key point position maps, position information of the current tab comprises:
determining a position of a marking frame in the key point position map for any key point position map of the multiple key point position maps; and
determining the position of the marking frame as a position of the corner point in the tab image.

9. The method according to claim 1, wherein the current tab comprises a positive electrode tab and a negative electrode tab; and
the determining, based on the position information, an actual width of the current tab comprises:
determining two corner points of the positive electrode tab and two corner points of the negative electrode tab;
determining an Euclidean distance between the two corner points of the positive electrode tab as the actual width of the positive electrode tab; and
determining an Euclidean distance between the two corner points of the negative electrode tab as the actual width of the negative electrode tab.

10. A computer device, comprising a processor and a memory, the memory being configured to store at least one computer program, the at least one computer program, when executed by the processor, causing the computer device to implement a method for detecting tab misalignment in a lithium-ion battery cell including:
performing key point detection on a tab image of a current tab of a lithium-ion battery cell to obtain multiple key point position maps indicating multiple corner points of the current tab respectively;
determining, based on the multiple key point position maps, position information of the current tab, the position information indicating positions of the multiple corner points of the current tab in the tab image;
determining, based on the position information, an actual width of the current tab; and
determining that the current tab is misaligned when a difference between the actual width and a preset width that is greater than a difference threshold.

11. The computer device according to claim 10, wherein the performing key point detection on a tab image to obtain multiple key point position maps comprises:
processing the tab image by using a key point detection model, to obtain multiple key point heat maps.

12. The computer device according to claim 11, wherein the key point detection model is generated by:
acquiring a training data set, the training data set comprising at least one sample image of a first sample tab taken under front irradiation, the sample image being marked with real position information corresponding to corner points of the first sample tab;
processing the sample image by using a first detection model, to obtain multiple sample key point heat maps, the sample key point heat maps being used for indicating multiple corner points of the first sample tab respectively, and one corner point corresponding to one sample key point heat map; and
adjusting, based on the real position information marked on the sample image and the multiple sample key point heat maps, parameters of the first detection model, to obtain the key point detection model.

13. The computer device according to claim 10, wherein the performing key point detection on a tab image of a current tab of a lithium-ion battery cell to obtain multiple key point position maps comprises:
performing feature extraction on the tab image, to obtain a first feature map;
performing feature extraction on a backlit image, to obtain a second feature map, the backlit image being an image of the current tab taken under back irradiation;
fusing the first feature map and the second feature map, to obtain a fused feature map; and
performing key point detection based on the fused feature map, to obtain the multiple key point position maps.

14. The computer device according to claim 10, wherein the performing key point detection on a tab image of a current tab of a lithium-ion battery cell to obtain multiple key point position maps comprises:
performing target detection on the tab image by using a target detection model, to obtain the multiple key point position maps.

15. The computer device according to claim 14, wherein the target detection model is generated by:
acquiring a sample data set, the sample data set comprising at least one image of a second sample tab taken under front irradiation, the image in the sample data set being marked with sample marking frames, the sample marking frame being an square area centered on a corresponding corner point of the second sample tab;
processing the image in the sample data set by using a second detection model, to obtain multiple sample key point position maps, the sample key point position maps being used for indicating multiple corner points of the second sample tab respectively, and one corner point corresponding to one sample key point position map; and
adjusting, based on the sample marking frames on the image in the sample data set and the multiple sample key point position maps parameters of the second detection model, to obtain the target detection model.

16. The computer device according to claim 10, wherein the multiple key point position maps are multiple key point heat maps, and the determining, based on the multiple key point position maps, position information of the current tab comprises:
determining a target pixel in the key point heat map for any key point heat map of the multiple key point heat maps, the target pixel having a pixel value that is a local maximum value in the key point heat map;
determining, in response to a total number of the target pixel being 1, a coordinate of the target pixel in the key point heat map as a position of one corner point of the current tab in the tab image;
determining, in response to the total number of the target pixel being greater than 1, coordinates of the multiple target pixels in the key point heat map;
performing interpolation on the coordinates of the multiple target pixels in the key point heat map to obtain a sub-pixel coordinate; and
determining the sub-pixel coordinate as a position of one corner point of the current tab in the tab image.

17. The computer device according to claim 10, wherein the determining, based on the multiple key point position maps, position information of the current tab comprises:
determining a position of a marking frame in the key point position map for any key point position map of the multiple key point position maps; and
determining the position of the marking frame as a position of the corner point in the tab image.

18. The computer device according to claim 10, wherein the current tab comprises a positive electrode tab and a negative electrode tab; and
the determining, based on the position information, an actual width of the current tab comprises:
determining two corner points of the positive electrode tab and two corner points of the negative electrode tab;
determining an Euclidean distance between the two corner points of the positive electrode tab as the actual width of the positive electrode tab; and
determining an Euclidean distance between the two corner points of the negative electrode tab as the actual width of the negative electrode tab.

19. A non-transitory computer-readable storage medium storing at least one computer program therein, the at least one computer program, when executed by a processor of a computer device, causing the computer device to implement a method for detecting tab misalignment in a lithium-ion battery cell including:
performing key point detection on a tab image of a current tab of a lithium-ion battery cell to obtain multiple key point position maps indicating multiple corner points of the current tab respectively;
determining, based on the multiple key point position maps, position information of the current tab, the position information indicating positions of the multiple corner points of the current tab in the tab image;
determining, based on the position information, an actual width of the current tab; and
determining that the current tab is misaligned when a difference between the actual width and a preset width that is greater than a difference threshold.

20. The non-transitory computer-readable storage medium according to claim 19, wherein the multiple key point position maps are multiple key point heat maps, and the determining, based on the multiple key point position maps, position information of the current tab comprises:
determining a target pixel in the key point heat map for any key point heat map of the multiple key point heat maps, the target pixel having a pixel value that is a local maximum value in the key point heat map;
determining, in response to a total number of the target pixel being 1, a coordinate of the target pixel in the key point heat map as a position of one corner point of the current tab in the tab image;
determining, in response to the total number of the target pixel being greater than 1, coordinates of the multiple target pixels in the key point heat map;
performing interpolation on the coordinates of the multiple target pixels in the key point heat map to obtain a sub-pixel coordinate; and
determining the sub-pixel coordinate as a position of one corner point of the current tab in the tab image.
